(19) United States
(12) Patent Application Publication
(10) Pub. No.: US 2026/0156305 A1
(43) Pub. Date: Jun. 4, 2026

(54) ENCODING AND DECODING A POINT CLOUD WITH DENSITY VALUES

(71) Applicant: Telefonaktiebolaget LM Ericsson (publ), Stockholm (SE)

(72) Inventors: Niclas SVENSSON, Stockholm (SE); Volodya GRANCHAROV, Solna (SE); Sigurdur SVERRISSON, Kungsängen (SE)

(73) Assignee: Telefonaktiebolaget LM Ericsson (publ), Stockholm (SE)

(21) Appl. No.: 19/125,529

(22) PCT Filed: Oct. 31, 2022
(86) PCT No.: PCT/EP2022/080363

§ 371 Date: Apr. 29, 2025

(51) Int. Cl. H04N 19/96; H04N 19/119; H04N 19/91

(52) U.S. Cl. CPC H04N 19/96; H04N 19/119; H04N 19/91

(57) ABSTRACT

It is provided a method for encoding a point cloud within a volume, the method being performed in an encoder. The method comprises: recursively splitting the volume into sub-volumes until each sub-volume satisfies a completion criterion, in which case the sub-volume is an end sub-volume; estimating, for each end sub-volume comprising points, its density of points, by selecting a density value, from a set of pre-selected density values, that is closest to the density of points of the end sub-volume; encoding the density of the sub-volumes by encoding a general mode density value, being the most common density value of the sub-volumes, and encoding density values of any sub-volumes comprising points, where the density value of the sub-volume differs from the general mode density value; and providing indications of the sub-volumes and the encoded density values. Corresponding embodiments for the decoder side are also provided.

### TECHNICAL FIELD

The present disclosure relates to the field of three-dimensional (3D) point clouds, and in particular to encoding and decoding a point cloud with density values

### BACKGROUND

A 3D (three-dimensional) point cloud is an unstructured set of coordinates in 3D space, which can be used to capture the scene geometry and scale, i.e., to represent 3D structures from the physical world. This set of 3D points can be denoted as

$$Ω = {( {X}_{k} , {Y}_{k} , {Z}_{k} )}_{k = 1}^{K} ,$$

where K is the number of points.

Typical point clouds range in size from a few kB to several GBs, which puts stress on any application requiring storage and/or transmission of such point clouds. Therefore, an efficient point cloud compression solution is desired for many end-user XR (extended reality) and industrial applications relying on 3D models/maps.

Graziosi et al, 2020. “An overview of ongoing point cloud compression standardization activities: video-based (V-PCC) and geometry-based (G-PCC)”. APSIPA Transactions on Signal and Information Processing, 9(1), discloses Geometry based Point Cloud Compression (G-PCC) according to the Motion Picture Experts Group (MPEG). G-PCC uses octree coding to compress the scene geometry. The input point cloud is contained within a volume D×D×D. The point cloud is then iteratively segmented into 8 sub-volumes with dimensions

$$\frac{D}{2} \times \frac{D}{2} \times \frac{D}{2} .$$

If a sub-volume (sometimes called sub-cube or octant) does not contain any points, it is unoccupied, and the segmentation process for this branch of the tree is terminated. This generates a tree structure, denoted an octree.

In lossy point cloud compression schemes, the octree is encoded to a pre-determined depth (level), which results in a certain size of sub-volumes at the lowest level of the octree, e.g., 64×64×64, which is much smaller volume than the cube that captures the entire point cloud (top level of octree), which e.g. could be 65 536×65 536×65 536. The set of 3D points contained in each sub-volume is encoded and transmitted.

In the prior art, the distribution of points in the lowest level cube can be determined based on mapping points to a surface. While this is helpful, this model is not always an accurate reflection of point distribution.

### SUMMARY

One object is to encode a point cloud in a manner that more accurately represents the point cloud compared to the prior art.

According to a first aspect, it is provided a method for encoding a point cloud within a volume, the method being performed in an encoder. The method comprises: recursively splitting the volume into sub-volumes until each sub-volume satisfies a completion criterion, in which case the sub-volume is an end sub-volume; estimating, for each end sub-volume comprising points, its density of points, by selecting a density value, from a set of pre-selected density values, that is closest to the density of points of the end sub-volume; encoding the density of the sub-volumes by encoding a general mode density value, being the most common density value of the sub-volumes, and encoding density values of any sub-volumes comprising points, where the density value of the sub-volume differs from the general mode density value; and providing indications of the sub-volumes and the encoded density values.

The encoding may comprise recursively assigning each parent volume a parent mode density value, being the most common density value of its sub-volumes, and encoding density values of any sub-volume of the parent whose density value differs from the parent mode density value.

The encoding may comprise, when there are at least two equal most common density values of the sub-volumes of a parent volume, selecting one, of the at least to two equal most common density values, for the parent that is most common for other parts of the volume.

The encoding may comprise applying entropy coding of the density values to be encoded.

The estimating, for each end sub-volume comprising points, its density of points, may comprise determining a surface mapping to points of each end sub-volume and determining, for each end sub-volume, a density of points of the surface.

The estimating, for each end sub-volume, its density of points, may comprise determining its density as the inverse of a median value of the distance to the nearest neighbour for each point of the surface.

The estimating, for each end sub-volume, its density of points, may comprise determining its density as a quote between a number of voxels of the surface of the end sub-volume that are occupied, and the number of total voxels of the surface.

According to a second aspect, it is provided an encoder for encoding a point cloud within a volume. The encoder comprises: a processor; and a memory storing instructions that, when executed by the processor, cause the encoder to: recursively split the volume into sub-volumes until each sub-volume satisfies a completion criterion, in which case the sub-volume is an end sub-volume; estimate, for each end sub-volume comprising points, its density of points, by selecting a density value, from a set of pre-selected density values, that is closest to the density of points of the end sub-volume; encode the density of the sub-volumes by encoding a general mode density value, being the most common density value of the sub-volumes, and encoding density values of any sub-volumes comprising points, where the density value of the sub-volume differs from the general mode density value; and provide indications of the sub-volumes and the encoded density values.

The instructions to encode may comprise instructions that, when executed by the processor, cause the encoder to recursively assign each parent volume a parent mode density value, being the most common density value of its sub-volumes, and encode density values of any sub-volume of the parent whose density value differs from the parent mode density value.

The instructions to encode may comprise instructions that, when executed by the processor, cause the encoder to, when there are at least two equal most common density values of the sub-volumes of a parent volume, select one, of the at least to two equal most common density values, for the parent that is most common for other parts of the volume.

The instructions to encode may comprise instructions that, when executed by the processor, cause the encoder to apply entropy coding of the density values to be encoded.

The instructions to estimate, for each end sub-volume comprising points, its density of points, may comprise instructions to determine a surface mapping to points of each end sub-volume and determining, for each end sub-volume, a density of points of the surface.

The instructions to estimate, for each end sub-volume, its density of points, may comprise instructions that, when executed by the processor, cause the encoder to determine its density as the inverse of a median value of the distance to the nearest neighbour for each point of the surface.

The instructions to estimate, for each end sub-volume, its density of points, may comprise instructions that, when executed by the processor, cause the encoder to determine its density as a quote between a number of voxels of the surface of the end sub-volume that are occupied, and the number of total voxels of the surface.

According to a third aspect, it is provided a computer program for encoding a point cloud within a volume. The computer program comprises computer program code which, when executed on an encoder causes the encoder to: recursively split the volume into sub-volumes until each sub-volume satisfies a completion criterion, in which case the sub-volume is an end sub-volume; estimate, for each end sub-volume comprising points, its density of points, by selecting a density value, from a set of pre-selected density values, that is closest to the density of points of the end sub-volume; encode the density of the sub-volumes by encoding a general mode density value, being the most common density value of the sub-volumes, and encoding density values of any sub-volumes comprising points, where the density value of the sub-volume differs from the general mode density value; and provide indications of the sub-volumes and the encoded density values.

According to a fourth aspect, it is provided a computer program product comprising a computer program according to the third aspect and a computer readable means comprising non-transitory memory in which the computer program is stored.

According to a fifth aspect, it is provided a method for decoding an encoded point cloud within a volume, the method being performed in a decoder. The method comprises: obtaining indications of sub-volumes of the volume arranged in a hierarchy, wherein each sub-volume that is not a parent of additional sub-volumes is an end sub-volume; obtaining encoded density values, comprising a general mode density value, being the most common density value of the sub-volumes, and density values of any sub-volume whose density value differs from the general mode density value; applying, for all sub-volumes of each parent volume, the density value of the parent volume, except for sub-volumes of the parent volume that are specified to have a different density value than the parent volume; and providing points in each end sub-volume according to the applied density value.

The method may further comprise: obtaining, for each end sub-volume comprising points, an indication of a surface of the end sub-volume, in which case the providing points in each end sub-volume comprises providing points on the surface of each end sub-volume according to the applied density value.

According to a sixth aspect, it is provided a decoder for decoding an encoded point cloud within a volume. The decoder comprises: a processor; and a memory storing instructions that, when executed by the processor, cause the decoder to: obtain indications of sub-volumes of the volume arranged in a hierarchy, wherein each sub-volume that is not a parent of additional sub-volumes is an end sub-volume; obtain encoded density values, comprising a general mode density value, being the most common density value of the sub-volumes, and density values of any sub-volume whose density value differs from the general mode density value; apply, for all sub-volumes of each parent volume, the density value of the parent volume, except for sub-volumes of the parent volume that are specified to have a different density value than the parent volume; and provide points in each end sub-volume according to the applied density value.

The decoder may further comprise instructions that, when executed by the processor, cause the decoder to: obtain, for each end sub-volume comprising points, an indication of a surface of the end sub-volume; in which case the instructions to provide points in each end sub-volume comprise instructions that, when executed by the processor, cause the decoder to provide points on the surface of each end sub-volume according to the applied density value.

According to a seventh aspect, it is provided a computer program for decoding an encoded point cloud within a volume. The computer program comprises computer program code which, when executed on a decoder causes the decoder to: obtain indications of sub-volumes of the volume arranged in a hierarchy, wherein each sub-volume that is not a parent of additional sub-volumes is an end sub-volume; obtain encoded density values, comprising a general mode density value, being the most common density value of the sub-volumes, and density values of any sub-volume whose density value differs from the general mode density value; apply, for all sub-volumes of each parent volume, the density value of the parent volume, except for sub-volumes of the parent volume that are specified to have a different density value than the parent volume; and provide points in each end sub-volume according to the applied density value.

According to an eighth aspect, it is provided a computer program product comprising a computer program according to the seventh aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating a point cloud for which embodiments presented herein can be applied;

FIG. 2 is a schematic diagram illustrating the encoding and decoding of a point cloud, e.g. the point cloud of FIG. 1;

FIG. 3 is a schematic diagram illustrating an octree split of a volume encompassing a point cloud, e.g. the point cloud of FIG. 1;

FIG. 4 is a schematic diagram illustrating the logical structure of an octree;

FIGS. 5A-B are schematic diagram illustrating the mapping of surfaces mapping to points of a sub-volume, e.g. a sub-volume of FIG. 3;

FIGS. 6A-B are schematic diagram illustrating reconstruction of points on a surface of a sub-volume, e.g. a sub-volume of FIG. 3, when density encoding is not applied;

FIGS. 7A-B are schematic diagram illustrating reconstruction of points on a surface of a sub-volume, e.g. a sub-volume of FIG. 3, when density encoding is applied;

FIGS. 8A-B are schematic diagram illustrating embodiments of density estimation of points on a surface of a sub-volume, e.g. a sub-volume of FIG. 3;

FIG. 9 is a flow chart illustrating embodiments of methods for encoding a point cloud within a volume;

FIGS. 10A-B are flow charts illustrating embodiments of methods for decoding a point within a volume;

FIG. 11 is a schematic diagram illustrating components of the encoder and decoder of FIG. 2 according to one embodiment;

FIG. 12 is a schematic diagram showing functional modules of the encoder of FIG. 2 according to one embodiment;

FIG. 13 is a schematic diagram showing functional modules of the decoder of FIG. 2 according to one embodiment; and

FIG. 14 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, point clouds are encoded in an improved manner compared to the prior art. More specifically, it is provided a point cloud encoding that better preserves the point density of the original point cloud. At the encoder side, the point density is estimated at the deepest level of the octree (or other volume splitting structure). The estimated point density propagates up the tree. Only when there are exceptions to the most common density is this encoded for a volume node. The densities are encoded and transmitted as an attribute to relevant nodes of the octree. At the decoder, the encoded densities propagate down the tree (while applying exceptions). The density is used to populate the reconstructed point cloud to more accurately correspond to the original point cloud.

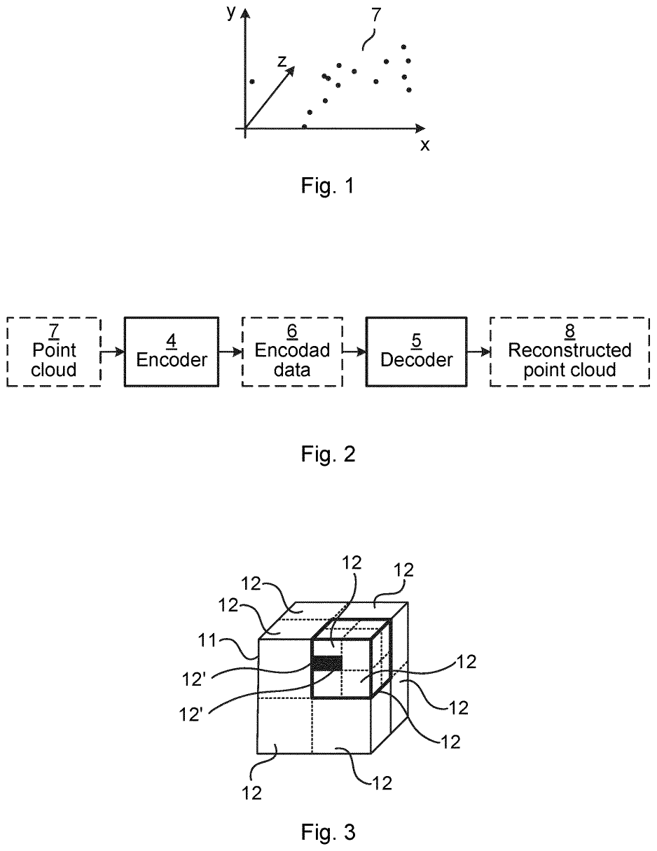

FIG. 1 is a schematic diagram illustrating a point cloud for which embodiments presented herein can be applied. A 3D (three-dimensional) point cloud 7 is shown in a 3D coordinate system. As explained above, the point cloud 7 is an unstructured set of coordinates in the 3D space, which can be used to capture the scene geometry and scale, i.e., to represent 3D structures from the physical world. This set of 3D points can be denoted as

$$Ω = {( {X}_{k} , {Y}_{k} , {Z}_{k} )}_{k = 1}^{K} ,$$

where K is the number of points.

Point clouds of real-world scenes can be generated using different techniques, e.g., active scanning by means of Lidar, passive scanning by means of visual odometry, etc. Regardless of the point cloud generation method, the point cloud distribution differs across the volume. In terms of 3D point occupancy, certain regions might be very sparse while others might be dense. This is a result of distance from the scanner, albedo (reflectiveness) of surfaces, amount of texture, occlusions, etc.

FIG. 2 is a schematic diagram illustrating the encoding and decoding of a point cloud 7, e.g. the point cloud of FIG. 1. An input point cloud 7 is provided to the encoder 4. The encoder 4 encodes the input point cloud 7, resulting in encoded data 6. The encoding involves compression, e.g. using sub-volume splitting such as an octree structure. The encoding can be a lossy compression to reduce the encoded data to a manageable size, for transmission and/or storage.

When the point cloud is to be reconstructed, a decoder 5 decodes the encoded data 6, resulting in a reconstructed point cloud 8. Since the encoding includes lossy compression, the reconstructed point cloud 8 will (most likely) not be identical to the input point cloud 7. However, according to embodiments presented herein, accuracy between the reconstructed point cloud 8 and the input point cloud 7 is improved by including density values in the encoding. Moreover, the encoding of the density values is performed in a very efficient manner, as explained in further detail below.

FIG. 3 is a schematic diagram illustrating an octree split of a volume 11 encompassing a point cloud, e.g. the point cloud 7 of FIG. 1. The volume 11 is recursively split into sub-volumes 12. This proceeds until each sub-volume satisfies a completion criterion. For instance, one completion criterion is that the sub-volume is empty, i.e. that it has no points in it. Another completion criterion can be that the sub-volume is at the maximum depth, i.e. the number of splits from the original volume 11. The maximum depth is defined to achieve compression, where there is a balance between accuracy and compression level. When a sub-volume satisfies a completion criterion, the sub-volume is denoted an end sub-volume 12′.

In an octree split, each volume is a cube, and each split is a split of the higher level cube into eight equally sized sub-volumes in the form of cubes. However, it is to be noted that there are other ways to structure and split a volume in sub-volumes, such as k-d tree, etc.

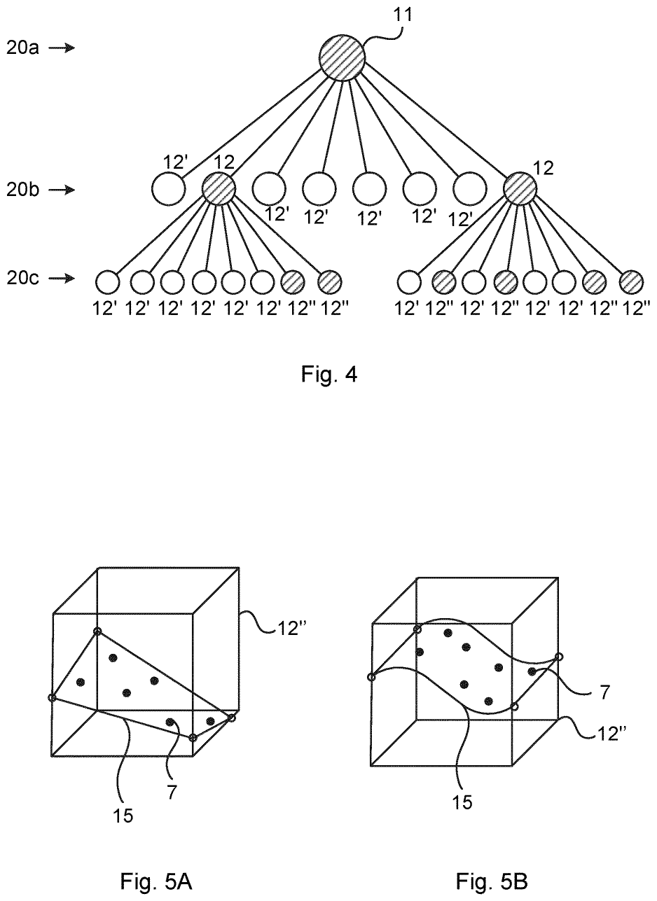

FIG. 4 is a schematic diagram illustrating the logical structure of an octree. In this example, there are three levels, i.e. the depth is three. For level 0, the (top) level 20a, the only volume 11 comprises eight sub-volumes 12, forming part of the level one 20b. Here, the (in order left to right) second sub-volume 12 and the eighth sub-volume 12 contain points. The other volumes 12′ on level one 20b are empty end sub-volumes 12′. Each one of the second sub-volume 12 and the eighth sub-volume 12 contain eight subordinate sub-volumes on a level two 20c. On level two 20c, the first set of sub-volumes contain (from left to right) six empty end sub-volumes 12′ and two end sub-volumes 12″ comprising points. The second set of sub-volumes contain, from left to right an empty end sub-volume 12′, an end sub-volume 12″ comprising points, an empty end sub-volume 12′, an end sub-volume 12″ comprising points, two empty end sub-volumes 12′, an end sub-volume 12″ comprising points, and an empty end sub-volume 12′.

The octree can be expressed in code, for level one 20b, 01000001, and for level two 20c, 00000011, 01010010. In the code, a ‘0’ indicates an empty sub-volume and a ‘1’ indicates that there is at least one point within the sub-volume. In this simple example, the bottom level is level two 20c, i.e. the depth of the sub-volume structure is two.

FIGS. 5A-B are schematic diagram illustrating the mapping of surfaces 15 mapping to points of a sub-volume, e.g. a sub-volume of FIG. 3. It has been found that an efficient way to encode the points of an end-sub volume 12′ is to map the points to a surface 15′. FIG. 5A discloses how a G-PCC's Trisoup estimate is mapped to the points 7 within the end sub-volume 12″. FIG. 5B discloses a general case of fitting a (non-planar) surface over the 3D points 7 within a the end sub-volume 12″.

The surface mapping can be done by fitting a surface 15 to the 3D points in each the end sub-volume 12″. The specific solution deployed by G-PCC is called Trisoup, and assumes that 3D points lie on a plane within each sub-volume, as illustrated in FIG. 5A. Such surfaces 15 can be encoded and form part of the encoded data for the point cloud.

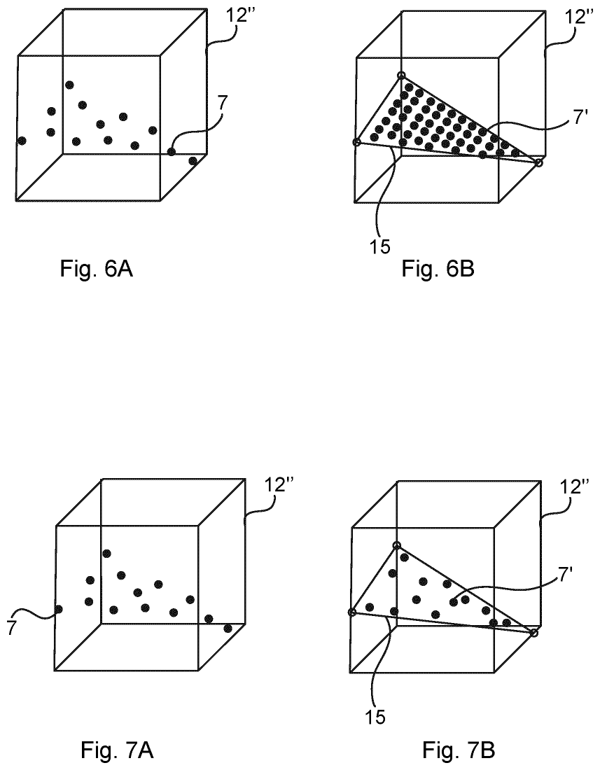

FIGS. 6A-B are schematic diagram illustrating reconstruction of points on a surface 15 of a sub-volume, e.g. a sub-volume of FIG. 3, when density encoding is not applied. FIG. 6A illustrates points of an end sub-volume 12″. A surface 15 is then encoded that maps to the points 7 and is transmitted to the decoder 5. When the decoder reconstructs the points in the end sub-volume 12″, shown in FIG. 6B, it fills the surface 15 with reconstructed points 7′ of all voxels intersecting the surface 15. This is how the prior art reconstructs the points. The reconstructed points 7′ are thus provided with much higher density than the original points 7, leading to significant discrepancy in the deconstruction.

FIGS. 7A-B are schematic diagram illustrating reconstruction of points on a surface 15 of a sub-volume, e.g. a sub-volume of FIG. 3, when density encoding is applied. According to embodiments presented herein, a density is encoded for each end sub-volume 12″ comprising points. FIG. 7A is the same as FIG. 6A, i.e. showing the original (pre-encoding) points 7 of an end sub-volume 12″. In FIG. 7B, however, the reconstructed points 7′ in the end sub-volume 12″ are generated while considering point density. It can be seen how the reconstructed points 7′ in FIG. 7B bear much closer resemblance to the original point cloud 7 in comparison with the reconstructed points 7′ of 6B.

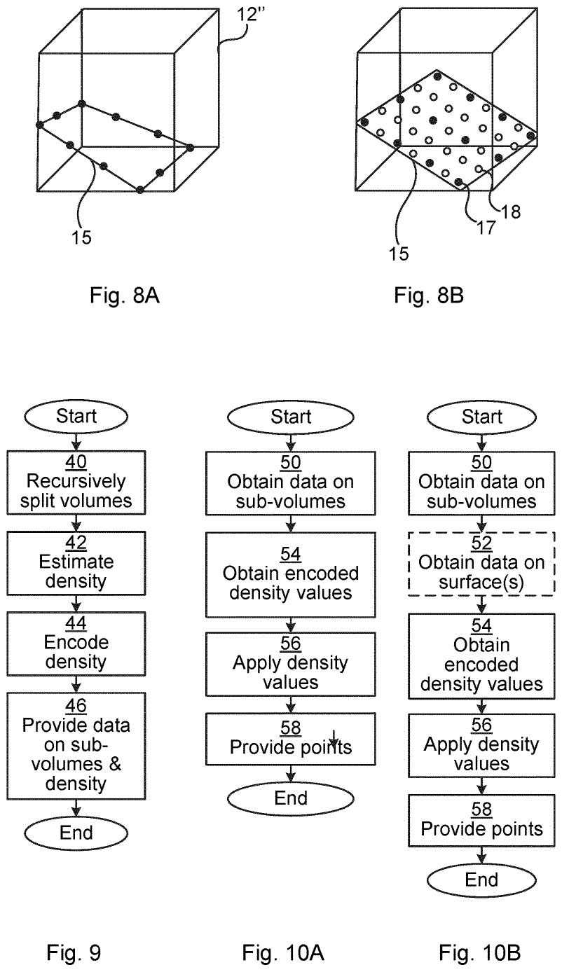

FIGS. 8A-B are schematic diagram illustrating embodiments of density estimation of original points on a surface 15 of a sub-volume, e.g. a sub-volume of FIG. 3. In FIG. 8A, it is shown how a surface is mapped to points of the end sub-volume 12″. Only points that lie on the edges of the surface 15 are illustrated. A distance to the closest neighbour (closest occupied voxel) on the edge can be used to estimate the density on the surface of the sub-volume, as described in more detail below.

FIG. 8B shows how reconstructed points (filled points) are distributed based on the density determined from FIG. 8A. Unfilled rings represent potential points in voxels intersected by the surface 15. In this example N_{occupied}=12, while Nₜₒₜₐₗ=35.

FIG. 9 is a flow chart illustrating embodiments of methods for encoding a (3D) point cloud within a (3D) volume.

In a recursively split volumes step 40, the encoder 4 recursively splits the volume 11 into sub-volumes 12 until each sub-volume 12 satisfies a completion criterion, in which case the sub-volume 12 is an end sub-volume 12′, 12″, e.g. as described with reference to FIG. 3 above.

In an estimate density step 42, the encoder 4 estimates, for each end sub-volume 12″ comprising points, its density of points. The estimating comprises selecting a density value, from a set of pre-selected density values, that is closest to the density of points of the end sub-volume 12′. The depth of the structure (e.g. octree) is determined by the codec profile and depends on the application and type of processed point cloud, but regardless of the depth, the solution performs density estimation step for each end sub-volume 12″ that contains points.

In one embodiment, the encoder 4 determines a surface 15 mapping to points of each end sub-volume 12′, e.g. as described with reference to FIGS. 5A-B above. In this case, the encoder 4 determines, for each end sub-volume 12″ comprising points, a density of points of the surface 15.

In one embodiment, the density of each end sub-volume is determined as the inverse of a median value of the distance to the nearest neighbour for each point of the surface 15. Optionally, only points on edges of the surface 15 are considered for the density calculation.

In this embodiment, let us denote the set of 3D points that lie on the edges of the surface 15 that we want to transmit within given sub-volume as Ω and assume this set have cardinality K, e.g. as illustrated in FIG. 8A. For all K points, in each of the edges, find the nearest neighbour, and store the distance to it. This will generate a vector of K distances v=[d₁, d₂, . . . , d_{K}]. The median of this vector is calculated, and its inverse is used as a measure of density ρⁱⁿ. This can be described according to:

$$v = zeros ( [ 1 , K ] )$$

For k in length(v):

$${v}_{k} = NearestNeighbor ( {Ω}_{k} , Ω )$$

$${ρ}^{in} = \frac{1}{Median ( v )}$$

where vₖ denotes distance from point Ωₖ to its nearest neighbour in set Ω, and ρⁱⁿ denotes density of the end sub-volume 12″ comprising points.

In one embodiment, the density of each end sub-volume is determined as a quote between a number of voxels of the surface of the end sub-volume 12′ that are occupied, and the number of total voxels of the surface.

In this embodiment, the point density is estimated based on 3D points laying on the surface. As an example, point density could be calculated as the number of occupied plane voxels N_{occupied} normalized by the total number of plane voxels Nₜₒₜₐₗ, as illustrated by FIG. 8B and described above.

$${ρ}^{in} = \frac{{N}_{occupied}}{{N}_{total}}$$

In one embodiment, the point density is estimated as the average of surface densities or volume densities over all occupied voxels laying on the surface. That is, for a given point Ω[k] we count the number of occupied voxels within a circle or sphere with radius R. For the case of volume density:

$${ρ}_{k} = \frac{{N}_{occupied}}{\frac{4}{3} π {R}^{3}}$$

$${ρ}^{in} = Median ( {ρ}_{k} )$$

The presented embodiments for point density estimation provide different trade-off between precision and complexity, but all have in common that they are executed over the points of modelled surface. In other words, density is then estimated only for the surface that will be reconstructed at the decoder and in the general case this could be a subset of 3D points inside a sub-volume.

In an encode density step 44, the encoder encodes the density of the sub-volumes 12 by encoding a general mode density value, being the most common density value of the sub-volumes 12. Furthermore, density values are encoded of any sub-volumes 12 comprising points, where the density value of the sub-volume 12 differs from the general mode density value.

Optionally, the encoding comprises recursively assigning each parent volume a parent mode density value, being the most common density value of its sub-volumes 12, 12′. Density values are then encoded of any sub-volume 12, 12′ of the parent whose density value differs from the parent mode density value.

Optionally, the encoding comprises, when there are at least two equal most common density values of the sub-volumes 12, 12′ of a parent volume, selecting one, of the at least to two equal most common density values, for the parent that is most common for other parts of the volume 11.

Optionally, the encoding comprises applying entropy coding of the density values to be encoded. The entropy coding can e.g. be based on Huffman coding and/or arithmetic coding, which are both examples of lossless compressions.

This encoding will now be described in some more detail.

The estimated point densities ρⁱⁿ are first quantized by finding a closest entry ρ from a lookup table with pre-determined density values, e.g.,

$$ρ ∈ \{ \frac{1}{2} , \frac{1}{4} , … , \frac{3}{4} \} .$$

These quantized values are used to propagate densities up the tree of sub-volumes.

The quantized point density ρ exists for all non-empty nodes at the bottom of the sub-volume structure (e.g. octree). Transmitting directly all densities will result in significant increase of the size of the bitstream. Therefore, the concept of the proposed solution is to utilize the already created sub-volume structure to efficiently transit small number of densities. The procedure has an iterative nature and can be outlined as follows:

Starting at the bottom level, for a given branch, densities of the occupied nodes are used to calculate the mode (most frequent value in the set). Next, the mode propagates up to the parent (one level up in the sub-volume structure). In this way, the densities are estimated only at the bottom level, but the density values can be associated with upper levels, i.e., the density propagates up in the tree.

If all leaf nodes (end sub-volumes) of the same branch have the same density as the mode, the parent node takes ownership of the density. In other words, if certain density is encoded for the parent, it applies over all children. Explicit transmission of density of a particular node happens only when its density deviates from the mode, i.e., from the parent level.

If, for a certain branch, there are two or more densities that are equally frequent, a rule is defined to select which of the equally frequent densities will propagate to the parent, where the equally frequent densities are compared with the mode calculated over the entire level. The point density that is closest (potentially equal) to the mode of the entire level is then the one that propagates up the sub-volume structure. This is illustrated in a quadtree example in Table 1.

TABLE 1
Decision logic for propagation with equally frequent densities in an exemplary
quadtree.
ρ₀

| ρ₁₀ | | | | ρ₁₁ | | | | ρ₁₂ | | | | ρ₁₃ | | | |
|---|---|---|---|---|---|---|---|---|---|---|---|---|---|---|---|
| $\frac{1}{4}$ | $\frac{1}{4}$ | $\frac{1}{2}$ | $\frac{1}{2}$ | $\frac{1}{2}$ | $\frac{1}{2}$ | $\frac{1}{2}$ | $\frac{1}{2}$ | $\frac{1}{2}$ | $\frac{1}{2}$ | $\frac{1}{2}$ | $\frac{1}{2}$ | $\frac{1}{2}$ | $\frac{1}{2}$ | $\frac{1}{8}$ | $\frac{1}{8}$ |

Looking to Table 1 in detail, point densities ρ₁₁ and ρ₁₂ are easily assigned since all their children have density ½. Assigning density to ρ₁₀ and ρ₁₃ is done after comparing the competing densities of their children to the mode calculated over the entire lowest level (16 entries in this example). Since the mode density for the lowest level is ½, the candidates ¼ and ⅛ do not propagate up to the parent level. Instead, density ½ is selected for both ρ₁₀ and ρ₁₃, and we get

$${ρ}_{10} = {ρ}_{11} = {ρ}_{12} = {ρ}_{14} = \frac{1}{2}$$

and as a result the top level gets general mode density

$${ρ}_{0} = \frac{1}{2}$$

which is valid for all {ρ₁₀,ρ₁₁,ρ₁₂,ρ₁₄}. In this way only nodes at the bottom level, with density ¼ and ⅛ have to be encoded explicitly, since only those nodes are exception to the general mode density.

The quantized local densities ρ are represented by a prefix code ρ_{code} which is combined with positional codes of the sub-volume structure (as described below) and transmitted to the decoder.

TABLE 1
Example of encoding of the point density. ρ are set of
pre-determined values in a lookup table. ρ closest to ρⁱⁿ is
selected and the corresponding ρ_{code} transmitted to the decoder.

| ρ | ρ_{code} |
|---|---|
| ½ | 00 |
| ¼ | 01 |
| . | . |
| . | . |
| . | . |
| ¾ | 1101 |

The codes ρ_{code} in Table 1 can be based on entropy coding for further lossless compression of the encoding of the density values.

Looking again to the example illustrated by FIG. 4. To parse the bitstream for density indexing, the decoder can use two stop symbols: end_depth and end_tree. The first one indicates stop of transmitting symbols within current depth of the sub-volume structure. The second one indicates end of the bitstream for density indexing. The nomenclature for the indices of densities is ρ_{d,pos}, where d is the depth (level) and pos is the horizontal position of the element number on that level, as if all elements would exist, i.e., pos∈[0, 8^{d}−1]. Hence for level 1, pos∈[0, 7] and for level 2, pos∈[0, 63].

Three cases will now be described as illustratory examples of how point densities are determined in various scenarios, referring to the sub-volume structure example illustrated in FIG. 4. Depth denotes vertical layer and pos indicates a horizontal position within a certain depth.

$${ρ}_{2 , 14} = {ρ}_{2 , 15} as well as {ρ}_{2 , 57} = {ρ}_{2 , 59} = {ρ}_{2 , 62} , and {ρ}_{1 , 1} = {ρ}_{1 , 7} \qquad Case A$$

This is a simple case, where all densities in the example in FIG. 4 are equal. In this case the density propagates all the way up to the top of the tree and one single scalar value needs to be transmitted, i.e., density is associated only with the top level (depth 0) and is valid for all nodes of the sub-volume structure.

The code for this case can be expressed sis: depth₀,ρ_{code,0},end_tree. It is to be noted that depth₀ does not require any (horizontal) position to be specified.

$${ρ}_{2 , 14} = {ρ}_{2 , 15} as well as {ρ}_{2 , 57} = {ρ}_{2 , 59} = {ρ}_{2 , 62} , but {ρ}_{1 , 1} \neq {ρ}_{1 , 7} \qquad Case B$$

The point densities at depth 1 of the sub-volume structure that differ from the density propagated to the top are specified. No explicit encoding of density at the bottom level, since the density of their parents apply.

The code for this case can be expressed as: depth₀,ρ_{code,0},depth₁,pos₇,ρ_{code,1,7},end_tree. It is to be noted that depth₁ does require the (horizontal) position to be specified.

$${ρ}_{2 , 14} = {ρ}_{2 , 15} and {ρ}_{2 , 57} = {ρ}_{2 , 59} \neq {ρ}_{2 , 62} and {ρ}_{1 , 1} = {ρ}_{1 , 7} \qquad Case C$$

Here, the density is explicitly encoded of a node at depth 2 that deviates from the mode density, which has propagated to the top of the tree.

The code is: depth₀,ρ_{code,0},depth₂,pos₆₂,ρ_{code,2,62},end_tree

Since the sub-volume structure is available both at the encoder at the decoder, the depth and pos values can be efficiently compressed with codes generated on the fly. Since the code for sub-volume structure exemplified in in FIG. 4 is 01000001,00000011,01010010, there are 3 depth levels. depth 0 is a single node (top of the tree). depth 1 has only two possible pos values (the two occupied nodes) and depth 2 has only 5 possible pos values (5 occupied nodes at the bottom level). So, depth and pos are encoded by indexing occupied nodes using entropy codes, also known as prefix codes, such as Huffman, Elias, etc.

The code 01000001, 00000011, 01010010 of the sub-volume structure from the example in FIG. 4 generates the following codes to index the position of the encoded density:

The depth is encoded as: (0, 10, 11)

Pos at depth 0 is not encoded, as it is a single node

Pos at depth 1 is encoded as (0,1)

Pos at depth 2 is encoded as (00, 01, 100, 101, 110)

The mentioned codes here are prefix codes, e.g., Huffman codes (no codeword is a prefix to another codeword, which makes them uniquely decodable).

For instance, the last set of codes (00, 01, 100, 101, 110) is the set of codewords that are used to index the positions at depth level 2. There are 5 codewords, which correspond to the 5 positions at that depth level. These codes are more efficient than direct binary coding of numbers. As an example, if one needs to encode the five positions, the binary codewords would be (000, 001, 010, 011, 100), i.e. always three bits. Using the prefix coding, the average is less than three bits, which is thus more efficient.

In a provide data on sub-volumes and density step 46, the encoder 4 provides indications of the sub-volumes and the encoded density values, in the form of encoded data. As mentioned above, the encoded data can be provided to a decoder for reconstruction of the point cloud.

FIGS. 10A-B are flow charts illustrating embodiments of methods for decoding a point within a volume. First, embodiments illustrated by FIG. 10A will be described.

In an obtain data on sub-volumes step 50, the decoder 5 obtains indications of sub-volumes 12 of the volume 11 arranged in a hierarchy, wherein each sub-volume that is not a parent of additional sub-volumes is an end sub-volume 12′.

In an obtain encoded density values step 54, the decoder 5 obtains encoded density values. The encoded density values comprise a general mode density value, being the most common density value of the sub-volumes 12, and density values of any sub-volume 12 whose density value differs from the general mode density value.

In an apply density values step 56, the decoder 5 applies, for all sub-volumes of each parent volume, the density value of the parent volume, except for sub-volumes of the parent volume that are specified to have a different density value than the parent volume.

At the receiver side, codes of the sub-volume structure are received first, and the reconstructed sub-volume structure is used to generate the codes that index depth and position as described above for the encode density step 44. It is to be noted that the codes for indexing depth and position of the sub-volume structure are generated both at the encoder and decoder. This indexing allows the decoder to parse the bitstream with densities transmitted as attribute to the sub-volume structure, and associate point density ρ with particular nodes of the sub-volume structure.

In a provide points step 58, the decoder 5 provides points in each end sub-volume 12′ according to the applied density value, e.g. as shown in FIG. 7B and explained above.

A density at parent level is used as density of all children, except children with explicitly encoded density. After density is associated with every sub-volume at the bottom level, instead of populating every voxel that intersects the corresponding surfaces, p is used to create the correct spacing between occupied voxels. This procedure produces a result that resembles the original distribution of points on the surface, as illustrated in FIG. 7B and described above.

Looking now to FIG. 10B, in the interest of brevity and focus, only new or modified steps compared to the disclosure of FIG. 10A.

In an optional obtain data on surfaces step 52, the decoder 5 obtains, for each end sub-volume 12′, an indication of a surface 15 of the end sub-volume 12′. When this step is performed, the provide points step 38 comprises providing points on the surface of each end sub-volume 12′ according to the applied density value.

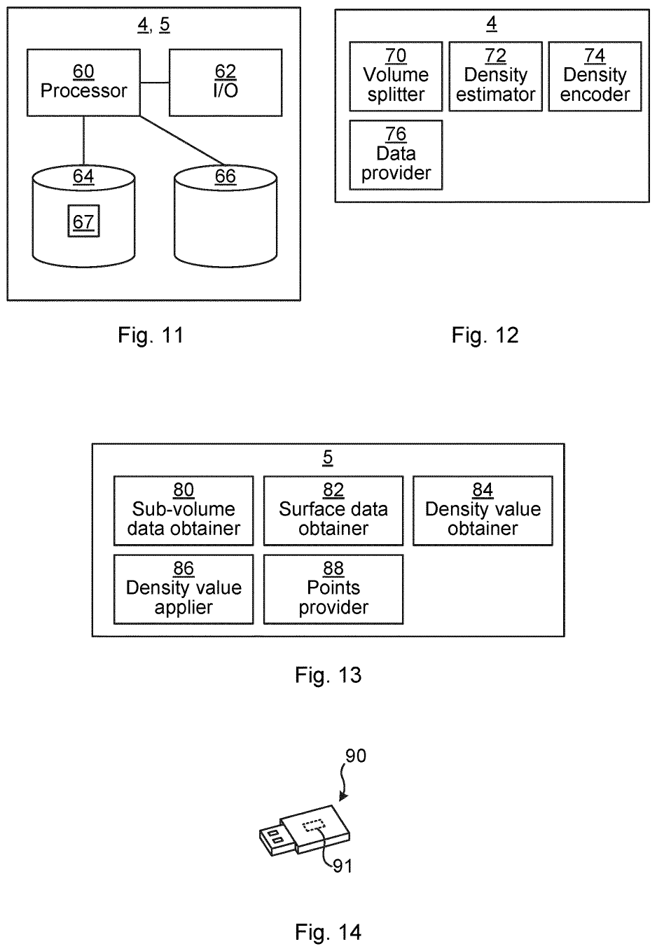

FIG. 11 is a schematic diagram illustrating components of the encoder 4 and decoder 5 of FIG. 2 according to one embodiment. It is to be noted that when the encoder 4 or decoder 5 is implemented in a host device, such as a smart phone or server, one or more of the mentioned components can be shared with the host device. A processor 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 9 above for the encoder, and the method described with reference to FIGS. 10A-B above for the decoder.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on Ethernet, and/or wireless communication, e.g. Wi-Fi, Bluetooth, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components are omitted in order not to obscure the concepts presented herein.

FIG. 12 is a schematic diagram showing functional modules of the encoder 4 of FIG. 2 according to one embodiment. The modules are implemented using software instructions such as a computer program executing in the encoder 4. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIG. 9.

A volume splitter 70 corresponds to step 40. A density estimator 72 corresponds to step 42. A density encoder corresponds to step 44. A data provider corresponds to step 76.

FIG. 13 is a schematic diagram showing functional modules of the decoder 5 of FIG. 2 according to one embodiment. The modules are implemented using software instructions such as a computer program executing in the decoder 5. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 10A-B.

A sub-volume data obtainer 80 corresponds to step 50. A surface data obtainer 82 corresponds to step 52. A density value obtainer 84 corresponds to step 54. A density value applier 86 corresponds to step 56. A points provider 88 corresponds to step 58.

FIG. 14 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 11. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-22. (canceled)

23. A method for encoding a point cloud within a volume, the method being performed in an encoder, the method comprising:
recursively splitting the volume into sub-volumes until each sub-volume satisfies a completion criterion, in which case the sub-volume is an end sub-volume;
estimating, for each end sub-volume comprising points, its density of points, by selecting a density value, from a set of pre-selected density values, that is closest to the density of points of the end sub-volume;
encoding the density of the sub-volumes by encoding a general mode density value, being the most common density value of the sub-volumes, and encoding density values of any sub-volumes comprising points, where the density value of the sub-volume differs from the general mode density value; and
providing indications of the sub-volumes and the encoded density values.

24. The method of claim 23, wherein the encoding comprises recursively assigning each parent volume a parent mode density value, being the most common density value of its sub-volumes, and encoding density values of any sub-volume of the parent whose density value differs from the parent mode density value.

25. The method of claim 24, wherein the encoding comprises, when there are at least two equal most common density values of the sub-volumes of a parent volume, selecting one, of the at least to two equal most common density values, for the parent that is most common for other parts of the volume.

26. The method of claim 23, wherein the encoding comprises applying entropy coding of the density values to be encoded.

27. The method of claim 23, wherein the estimating, for each end sub-volume comprising points, its density of points, comprises determining a surface mapping to points of each end sub-volume and determining, for each end sub-volume, a density of points of the surface.

28. The method of claim 27, wherein the estimating, for each end sub-volume, its density of points, comprises determining its density as the inverse of a median value of the distance to the nearest neighbor for each point of the surface.

29. The method of claim 27, wherein the estimating, for each end sub-volume, its density of points, comprises determining its density as a quote between a number of voxels of the surface of the end sub-volume that are occupied, and the number of total voxels of the surface.

30. An encoder for encoding a point cloud within a volume, the encoder comprising:
a processor; and
a memory storing instructions that, when executed by the processor, cause the encoder to:
recursively split the volume into sub-volumes until each sub-volume satisfies a completion criterion, in which case the sub-volume is an end sub-volume;
estimate, for each end sub-volume comprising points, its density of points, by selecting a density value, from a set of pre-selected density values, that is closest to the density of points of the end sub-volume;
encode the density of the sub-volumes by encoding a general mode density value, being the most common density value of the sub-volumes, and encoding density values of any sub-volumes comprising points, where the density value of the sub-volume differs from the general mode density value; and
provide indications of the sub-volumes and the encoded density values.

31. The encoder of claim 30, wherein the instructions to encode comprise instructions that, when executed by the processor, cause the encoder to recursively assign each parent volume a parent mode density value, being the most common density value of its sub-volumes, and encode density values of any sub-volume of the parent whose density value differs from the parent mode density value.

32. The encoder of claim 31, wherein the instructions to encode comprise instructions that, when executed by the processor, cause the encoder to, when there are at least two equal most common density values of the sub-volumes of a parent volume, select one, of the at least to two equal most common density values, for the parent that is most common for other parts of the volume.

33. The encoder of claim 30, wherein the instructions to encode comprise instructions that, when executed by the processor, cause the encoder to apply entropy coding of the density values to be encoded.

34. The encoder of claim 30, wherein the instructions to estimate, for each end sub-volume comprising points, its density of points, comprise instructions to determine a surface mapping to points of each end sub-volume and determining, for each end sub-volume, a density of points of the surface.

35. The encoder of claim 34, wherein the instructions to estimate, for each end sub-volume, its density of points, comprise instructions that, when executed by the processor, cause the encoder to determine its density as the inverse of a median value of the distance to the nearest neighbor for each point of the surface.

36. The encoder of claim 34, wherein the instructions to estimate, for each end sub-volume, its density of points, comprise instructions that, when executed by the processor, cause the encoder to determine its density as a quote between a number of voxels of the surface of the end sub-volume that are occupied, and the number of total voxels of the surface.

37. A non-transitory computer readable storage medium storing a computer program comprising computer program code which, when executed by an encoder causes the encoder to perform the method of claim 23.

38. A method for decoding an encoded point cloud within a volume, the method being performed in a decoder, the method comprising:
obtaining indications of sub-volumes of the volume arranged in a hierarchy, wherein each sub-volume that is not a parent of additional sub-volumes is an end sub-volume;
obtaining encoded density values, comprising a general mode density value, being the most common density value of the sub-volumes, and density values of any sub-volume whose density value differs from the general mode density value;
applying, for all sub-volumes of each parent volume, the density value of the parent volume, except for sub-volumes of the parent volume that are specified to have a different density value than the parent volume; and
providing points in each end sub-volume according to the applied density value.

39. The method of claim 38, further comprising:
obtaining, for each end sub-volume comprising points, an indication of a surface of the end sub-volume;
wherein the providing points in each end sub-volume comprises providing points on the surface of each end sub-volume according to the applied density value.

40. A decoder for decoding an encoded point cloud within a volume, the decoder comprising:
a processor; and
a memory storing instructions that, when executed by the processor, cause the decoder to:
obtain indications of sub-volumes of the volume arranged in a hierarchy, wherein each sub-volume that is not a parent of additional sub-volumes is an end sub-volume;
obtain encoded density values, comprising a general mode density value, being the most common density value of the sub-volumes, and density values of any sub-volume whose density value differs from the general mode density value;
apply, for all sub-volumes of each parent volume, the density value of the parent volume, except for sub-volumes of the parent volume that are specified to have a different density value than the parent volume; and
provide points in each end sub-volume according to the applied density value.

41. The decoder of claim 40, further comprising instructions that, when executed by the processor, cause the decoder to:
obtain, for each end sub-volume comprising points, an indication of a surface of the end sub-volume;
wherein the instructions to provide points in each end sub-volume comprise instructions that, when executed by the processor, cause the decoder to provide points on the surface of each end sub-volume according to the applied density value.

42. A non-transitory computer readable storage medium storing a computer program comprising computer program code which, when executed by a decoder causes the decoder to perform the method of claim 38.
